(19) United States
(12) Patent Application Publication
(10) Pub. No.: US 2026/0050266 A1
(43) Pub. Date: Feb. 19, 2026

(54) System

(71) Applicant: Softbank Group Corp., Tokyo (JP)

(72) Inventor: Kaori Sato, Tokyo (JP)

(21) Appl. No.: 19/300,147

(22) Filed: Aug. 14, 2025

(30) Foreign Application Priority Data
Aug. 19, 2024 (JP) 2024-138216

(51) Int. Cl. G05D 1/644; G05D 1/667; G05D 101/15; G05D 105/20; G05D 105/55; G05D 109/20; G05D 111/10

(52) U.S. Cl. CPC G05D 1/644; G05D 1/667; G05D 2101/15; G05D 2105/20; G05D 2105/55; G05D 2109/20; G05D 2111/10

(57) ABSTRACT

A system includes a processor that controls an operable flying device, controls an operable imaging means, performs real-time analysis of generated data using artificial intelligence processing means, calculates an optimal rescue route based on the analysis results, controls means for loading and transporting supplies with the flying device, controls means for deploying equipment in regions where communication is disrupted and collecting local condition data, analyzes the collected data to generate emergency response information, and communicates the emergency response information to external rescue organizations.

### CROSS-REFERENCE TO RELATED APPLICATION

This application is based on and claims priority under 35 USC 119 from Japanese Patent Application No. 2024-138216 filed on Aug. 19, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional disaster response systems, it is difficult to obtain accurate and real-time situational information in affected areas, especially when communications are disrupted. As a result, rescue operation planning, supply delivery, and information sharing with external relief organizations may be delayed or inefficient, leading to reduced survival rates and inefficient use of resources.

### SUMMARY

To solve these problems, the present invention provides a system comprising a processor that controls operable flying devices and imaging means, analyzes collected data in real time using artificial intelligence, calculates optimal rescue and transport routes, and enables efficient collection and delivery of supplies. The system further allows equipment deployment in communication-disrupted areas to collect local status data and generate emergency response information, which is then communicated promptly to relevant external relief organizations.

“Processor” means a hardware device or computing unit capable of executing instructions to control and coordinate the functions of various components within the system.

“Operable flying device” means an unmanned aerial vehicle or drone capable of autonomous or remote-controlled flight for purposes including data collection, equipment delivery, or transportation of supplies.

“Imaging means” means a camera, sensor, or other device capable of capturing visual or other sensory data from the environment.

“Artificial intelligence processing means” means a software or hardware module capable of analyzing collected data in real time using machine learning or deep learning algorithms.

“Means for loading and transporting supplies” means a component or mechanism, integrated into the flying device, capable of receiving, securing, transporting, and delivering relief supplies to specified locations.

“Means for deploying equipment in regions where communication is disrupted” means a functionality for delivering communication devices or sensors to areas without network connectivity, in order to facilitate the collection and relay of local condition data.

“Means for collecting local condition data” means a functionality or device intended to gather environmental, visual, or status information from disaster-affected sites.

“Means for analyzing collected data” means a module, algorithm, or unit that processes gathered information to extract insights regarding disaster status and urgent needs.

“Means for generating emergency response information” means a function or process producing actionable data, reports, or alerts based on the analysis of conditions in the disaster area.

“Means for communicating the emergency response information to external rescue organizations” means an interface, network, or protocol enabling the transmission of urgent and relevant information from the system to third-party relief agencies and authorities.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or”is employed to link three or more items in the present specification.

### First Exemplary Embodiment

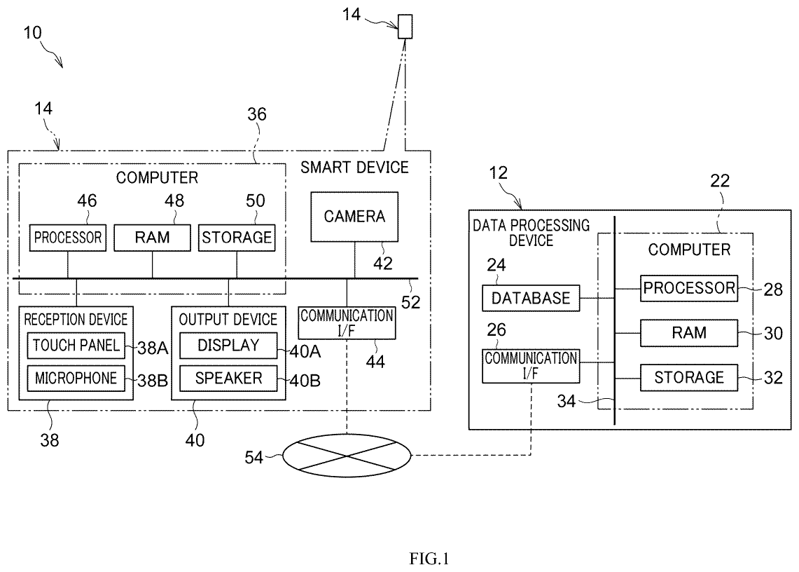

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

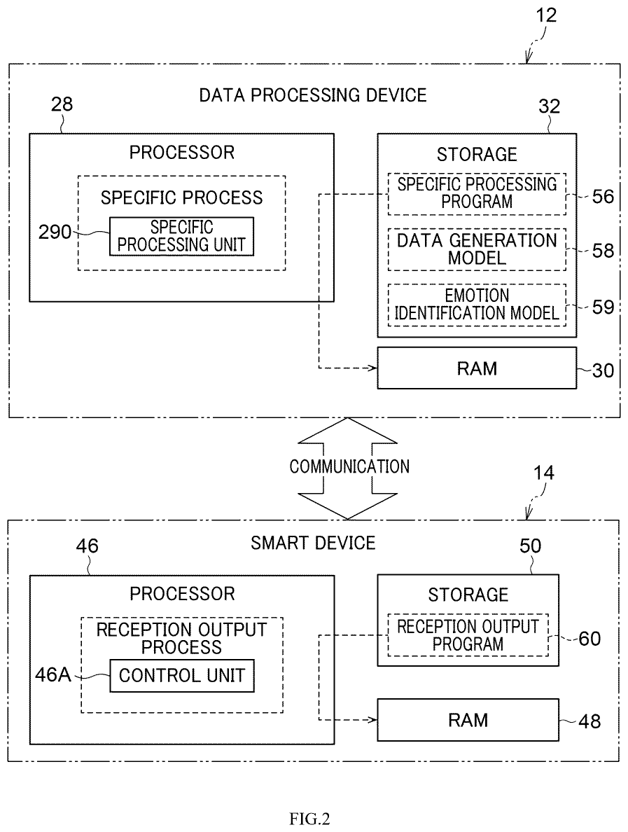

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In the event of large-scale or sudden disasters, it is extremely difficult to rapidly and accurately collect information about the affected area, calculate optimal rescue routes, and efficiently transport necessary supplies, particularly when communication infrastructure is disrupted. Conventional systems are limited in their ability to coordinate real-time information acquisition, route planning, and supply delivery utilizing advanced artificial intelligence, especially in communication blackout zones. Furthermore, challenges exist in automating the interpretation of diverse on-site data and generating actionable responses for external relief agencies in a timely manner.

The specific processing by the specific processing unit 290 of the data processing device 12 in Example 1 is realized by the following means.

The present invention provides a server comprising a processor configured to collect various types of information using unmanned mobile apparatus and an image acquisition apparatus, analyze and process real-time data with an artificial intelligence processing module, calculate optimal rescue movement routes based on analysis results, autonomously instruct unmanned mobile apparatus to transport goods, collect and analyze status data in communication blackout regions, generate emergency response information, transmit such information to external relief agencies, and utilize a generative artificial intelligence model with prompt sentence inputs in order to generate actionable situational analyses and plans. This enables rapid and accurate acquisition of on-site disaster information, optimized AI-driven rescue route planning and supply delivery, and efficient generation and distribution of emergency response instructions, including in areas lacking conventional communication infrastructure.

The term “unmanned mobile apparatus” refers to a transportation device capable of autonomous or remote-controlled movement without direct human operation, such as an unmanned aerial vehicle or drone, used for tasks including data collection and goods delivery. The term “image acquisition apparatus” refers to any device or system capable of capturing visual data, including but not limited to cameras and sensors, used for obtaining static images, video, or other visual information of an environment.

The term “artificial intelligence processing module” refers to a computational system or software that utilizes machine learning algorithms or artificial intelligence models to analyze, interpret, and derive insights from input data in real time.

The term “route calculation module” refers to a hardware or software component that determines the optimal path for movement or transportation based on input data such as maps, obstacles, hazards, and real-time analysis results.

The term “goods transport instruction” refers to a command or set of instructions issued by the processor directing the unmanned mobile apparatus to load, carry, and deliver specified items to a designated location.

The term “information acquisition equipment” refers to devices deployed in the field, particularly in areas with disrupted communications, for the purpose of collecting data about the local status, such as portable cameras, environmental sensors, or satellite communication devices.

The term “emergency information generation module” refers to a system or component that processes acquired data to identify, create, and prioritize emergency response information required for disaster management and relief operations.

The term “external terminal of relief agency” refers to the electronic devices or systems operated by external organizations, including relief teams, government institutions, or medical facilities, which receive and utilize emergency information provided by the present system.

The term “generative artificial intelligence model” refers to an artificial intelligence system capable of generating new content, conclusions, or plans by processing structured prompts and input data, supporting complex situational analyses and automated decision-making.

The term “prompt sentence” refers to a structured input query, statement, or instruction designed to guide the generative artificial intelligence model in producing relevant analyses, summaries, or action plans tailored to specific disaster scenarios.

In order to implement the present invention, a system is constructed comprising a server equipped with a processor, a plurality of unmanned mobile apparatuses (such as drones), one or more image acquisition apparatuses (such as high-resolution cameras and microphones), and appropriate communication hardware. The server executes various software modules including an artificial intelligence processing module, a route calculation module, an emergency information generation module, a generative artificial intelligence model, as well as components for handling prompt sentences and external information distribution.

The server manages and supervises the entire disaster response workflow. When a disaster notification is received, the server utilizes its network communication hardware (for example, LTE modules, satellite communication devices, or LAN connections) to receive information from government systems, weather agencies, or automated sensors. Upon recognizing an incident, the server records the details in a database system (such as a relational database management system).

The server then determines which unmanned mobile apparatuses are available for deployment using internal asset management software. The server generates specific mission parameters and flight plans, making use of mapping and route-finding software (for instance, a map API in combination with Dijkstra's algorithm or the A* algorithm). For data acquisition, the server issues instructions to drones to navigate to specific locations and to activate their onboard cameras and microphones. The image acquisition apparatus captures high-resolution images and audio data, which are then transmitted back to the server in real time via wireless network modules, such as LTE, 5G, or satellite networks.

Upon receiving real-time image, video, and audio data, the server stores and preprocesses these data sets using data processing middleware. The server then applies the artificial intelligence processing module, such as a generative AI model (for example, a system built on OpenAI's GPT-4 or similar machine learning models implemented with PyTorch or TensorFlow utilizing GPU hardware), to analyze the environmental data. The server may construct a prompt sentence like the following to facilitate detailed analysis:

“A magnitude 7 earthquake occurred in the city, isolating several neighborhoods. Please collect and analyze on-site data, then determine the fastest and safest rescue routes and suggest how to deliver emergency medical supplies.”

This prompt sentence, together with context data such as images and location information, is provided as input to the generative AI model. The model then generates a situational analysis, identifying hazard zones, collapsed buildings, isolated populations, or other urgent features. The server uses these results to calculate optimal rescue and supply delivery routes, taking into account obstacles, real-time geographic information, and the specific needs identified by the analysis.

The server also issues transport instructions to unmanned mobile apparatuses, directing them to load specified supplies (for example, water, medical kits, and food) using onboard containers and deliver these goods to designated destinations according to the computed routes. In areas where traditional communication infrastructure is unavailable or disrupted, the server instructs drones to carry information acquisition equipment (such as a digital camera or a satellite communication device) to local responders. The responders use these devices to collect local data, which is then transmitted or physically carried back to the server for analysis. The server analyzes the collected information, generates emergency response information prioritizing timely and appropriate actions, and shares this with external relief agencies and organizations via a secure network interface (for example, by using a REST API or HTTPS protocol).

The user—such as a rescue team member or relief coordinator—accesses real-time reports, rescue route recommendations, and supply delivery statuses via their terminal device, using dedicated software or a web-based interface provided by the system. The user can also submit feedback or new requests for analysis, which will be incorporated into the ongoing data acquisition and processing flow by the server.

In summary, the system is implemented using a combination of general-purpose computing hardware (such as server computers with high-performance CPUs and GPUs), unmanned mobile apparatuses (drones), image and sound acquisition devices, network hardware, and software services (including AI frameworks and data processing applications). Specific software components such as artificial intelligence models, route-finding algorithms, database management systems, and network interface protocols are combined to automate and optimize disaster response, real-time information gathering, analysis, route planning, and delivery operations, even when public communication infrastructure is not available.

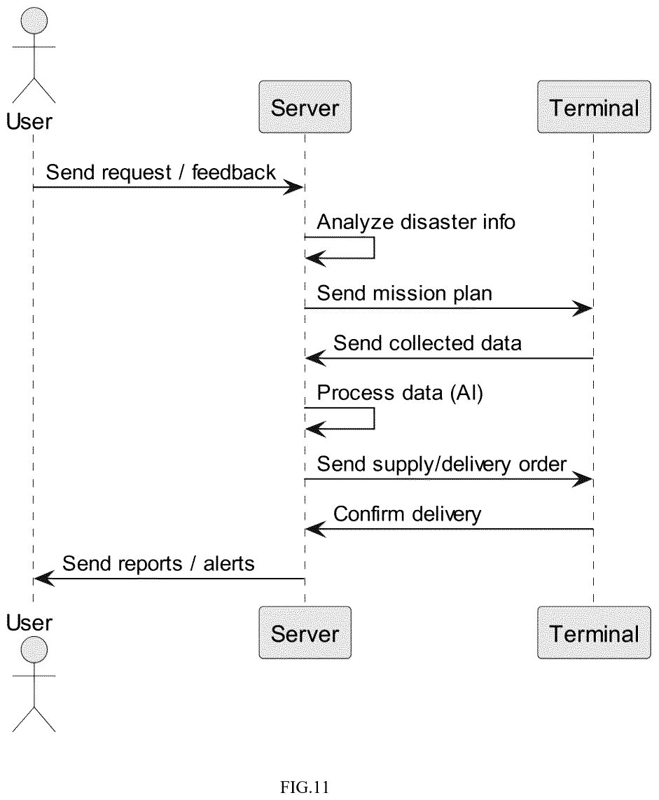

The following describes the processing flow using FIG. 11.

### Step 1:

Server receives disaster notification.

Input: Disaster alerts and information from government systems, weather bureaus, or automated sensors.

Processing: Server parses the type, location, magnitude, and timestamp of the disaster, and records this information in its database.

Output: Structured disaster event records in the database, and a trigger for the initial response process.

Specific Action: Server maintains a standby process that monitors multiple communication channels and automatically launches the workflow when a new disaster event is detected.

### Step 2:

Server evaluates available unmanned mobile apparatus resources and selects optimal units for deployment.

Input: Disaster location and status data from Step 1; internal resource inventory.

Processing: Server queries its inventory management subsystem and cross-checks proximity to the site, operational status, and battery level of all available unmanned mobile apparatus.

Output: Selection list of specific unmanned mobile apparatus and assignment records for the disaster response task.

Specific Action: Server filters out drones under maintenance or low battery and selects those within a set radius for fastest deployment.

### Step 3:

Server generates detailed mission plans and flight paths for each selected unmanned mobile apparatus.

Input: Geographic data for affected area, real-time map information, and drone capability data.

Processing: Server uses a mapping API and algorithms (such as A* or Dijkstra) to calculate the optimal flight route, designate waypoints, and define locations for data acquisition.

Output: Mission instruction set including launch coordinates, route, altitude, data collection points, and instructions for onboard apparatus.

Specific Action: Server customizes each plan based on local obstacles (e.g., tall buildings, no-fly zones) and time constraints.

### Step 4:

Terminal (unmanned mobile apparatus) receives the mission plan and initiates autonomous navigation.

Input: Mission instructions from the server.

Processing: Terminal conducts preflight system checks, uploads the flight plan, and self-calibrates navigation systems.

Output: Autonomous flight operation, arrival at designated waypoints, and activation of on-board image acquisition apparatus.

Specific Action: Terminal follows the received route, activates cameras and microphones at each waypoint, and records timestamped metadata with each dataset collected.

### Step 5:

Terminal transmits collected image, video, and audio data in real time to the server.

Input: Acquired media and sensor data.

Processing: Terminal establishes secure wireless communication (LTE/5G/satellite) and encodes media streams for efficient transmission.

Output: Real-time media streams and metadata transmitted to the server's designated endpoint.

Specific Action: Terminal prioritizes transmission of critical data (e.g., images with detected structural damage) when bandwidth is limited.

### Step 6:

Server preprocesses incoming data and applies the generative AI model for situational analysis.

Input: Real-time media streams from the terminal, along with a pre-defined or dynamically generated prompt sentence.

Processing: Server formats the AI prompt including disaster context and analysis goals, and submits media data with the prompt to the generative AI model (e.g., via an API). The AI model analyzes imagery, audio, and context, extracting features such as damaged infrastructure, blocked roads, and at-risk populations.

Output: Machine-readable disaster analysis reports, classification of danger zones, list of critical needs (e.g., first aid, shelter), and a summary generated by the model.

Specific Action: Server logs AI model results, associates findings with GPS coordinates, and archives analysis outputs for later auditing and human review.

### Step 7:

Server calculates and updates optimal rescue and supply delivery routes.

Input: Analysis results from the AI model, live map/obstacle data, inventory of supplies.

Processing: Server overlays identified danger areas, blocked or hazardous paths, and population needs onto a digital map, then uses the route calculation module to derive optimized movement plans.

Output: Updated rescue team and unmanned mobile apparatus route instructions, supply delivery plans detailing items and delivery order.

Specific Action: Server prioritizes routes to maximize survivor access and minimize exposure to hazards.

### Step 8:

Server sends supply loading and delivery instructions to terminal.

Input: Supply delivery plan and item lists.

Processing: Server issues specific loading instructions (what to carry, where to pick it up), updates the terminal's flight route for delivery, and transmits all necessary mission parameters.

Output: Terminal receives and acknowledges detailed loading and delivery instructions.

Specific Action: Terminal confirms supply loading is completed using onboard sensors (e.g., weight sensors) before initiating delivery flight.

### Step 9:

Terminal executes supply transportation and delivers goods to designated locations.

Input: Delivery instructions and supply manifest from server.

Processing: Terminal follows the specified route, tracks its position via GPS, and performs drop-off or handover at the precise location.

Output: Confirmation of successful supply delivery, including delivery time and location logs, sent back to server.

Specific Action: Terminal may visually document proof of delivery (e.g., photo of drop site) for server-side verification.

### Step 10:

Server handles communication-blackout scenarios by instructing terminal to deliver or collect data via portable information acquisition equipment.

Input: Identification of blackout area and selection of data acquisition equipment.

Processing: Server creates an alternative mission plan to deliver devices (such as cameras or satellite phones), instructs terminal accordingly, and monitors for device return or manual data transfer by field personnel.

Output: Transmission or physical return of collected field data to the server, which is then processed as in previous steps.

Specific Action: Local user/field responder uses the delivered device to capture local images or status, and hands the equipment off to the terminal on its return trip.

### Step 11:

Server generates and distributes emergency action reports to users and external agencies.

Input: Consolidated analysis results, location-based findings, and completed supply manifest logs.

Processing: Server prepares prioritized emergency action documents, formats reports for electronic delivery, and sends them via secure network protocols to users, relief organizations, and municipal authorities.

Output: Users receive real-time status updates, action recommendations, and situation summaries.

Specific Action: User accesses a secure portal to review reports, maps, and recommendations relevant to their region.

### Step 12:

User provides feedback or submits additional requests for analysis to server.

Input: User feedback, such as requests for further damage assessment or map updates.

Processing: Server queues new analysis or alters the mission plan based on user-submitted data, and initiates further drone flights or AI analysis as needed.

Output: Updates to the ongoing disaster response workflow, enabling iterative improvement and responsiveness.

Specific Action: User inputs a text request such as, “Please re-evaluate the landslide risk in district B,”which server processes and addresses in real time.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In the event of a natural disaster or emergency, rapid and accurate situational awareness as well as prompt delivery of relief supplies are essential for effective response and life-saving activities. However, conventional systems often face significant challenges such as limited communication infrastructure in affected areas, delayed collection and analysis of on-site information, inefficient rescue routing, and insufficient consideration for the emotional states of victims, all of which contribute to slower or less effective response. There is a need for a comprehensive system capable of real-time autonomous data acquisition, intelligent analysis including anomaly and emotion detection, optimal route calculation for rescue and relief operations, and seamless communication and feedback with external organizations and field users, even in areas with disrupted communication.

The specific processing by the specific processing unit 290 of the data processing device 12 in Application Example 1 is realized by the following means.

The present invention provides a server comprising a processor configured to control an aerial vehicle for autonomous data collection and supply transport, acquire and analyze multi-modal data in real time using a generative artificial intelligence model with prompt-based input, calculate optimal rescue and delivery routes based on analyzed results and geospatial data, estimate the emotional state of individuals from collected information, dynamically adapt operation strategies and prioritize rescue targets based on emotion and anomaly detection, and interface with user terminals and external agencies for seamless information sharing, feedback, and action coordination. This enables rapid, accurate, and intelligent disaster and emergency response through integrated autonomous operations, AI-based analysis, real-time decision making, and enhanced care for victims'emotional well-being, even in communication-impaired or highly dynamic environments.

The term “aerial vehicle” refers to a flying machine, such as a drone or unmanned aerial system, which is capable of autonomous or remote-controlled flight for the purposes of data acquisition and supply transport.

The term “imaging device” refers to an integrated apparatus capable of capturing visual and audio information, including but not limited to cameras and microphones, mounted on or deployed with the aerial vehicle.

The term “machine learning model” refers to a computer-implemented algorithm or network that analyzes input data in real time to identify anomalous situations, specific patterns, or objects, including generative artificial intelligence models that utilize prompt-based instructions.

The term “optimal route calculation” refers to a computational process by which the processor determines the most effective path for the aerial vehicle or rescue teams, based on geographic, environmental, and hazard data as well as analysis results.

The term “supply transport control” refers to the functionality by which the system manages the loading, delivery, and confirmation of goods or relief items to designated locations via the aerial vehicle.

The term “communication-impaired region” refers to an area where standard network communication infrastructures are unavailable, disrupted, or severely limited, requiring the deployment of alternative data acquisition devices.

The term “prompt sentence” refers to a text instruction or query input to the generative artificial intelligence model to guide its analysis or data generation from acquired sensory information.

The term “generative artificial intelligence model” refers to a computerized model that is capable of interpreting, processing, and generating data based on input prompts, specifically for analyzing complex or multi-modal data and extracting actionable results such as anomaly or emotion scores.

The term “external communication interface” refers to the set of protocols, hardware, and software enabling secure, real-time information exchange between the system and third-party organizations, agencies, or user terminals.

The term “emotion estimation analysis” refers to the process in which the system estimates the emotional status of individuals, such as fear, anxiety, or relief, from audio or visual data using artificial intelligence or machine learning techniques.

The term “user interface” refers to the hardware and/or software components that allow users to interact with the system, including real-time visualization, command input, feedback submission, and activity monitoring through user terminals.

### Embodiment for Implementing the Invention

This invention may be implemented as an integrated emergency response system comprising a server (processing unit), one or more aerial vehicles (terminals) equipped with imaging devices, and user terminals. The system utilizes machine learning models, including a generative artificial intelligence model, and prompt sentences for intelligent data analysis, as well as various hardware and software components as described below.

The server may consist of a general-purpose computing device with a processor, memory, network interface, and storage. The server executes software modules for data reception, analysis, route calculation, control command generation, emotion estimation, user interface management, and external communication. The server uses commercial or open-source solutions for major functions: for example, Linux OS, Python programming environment, PostgreSQL database, OpenCV for image handling, and APIs compatible with the aerial vehicle vendor's SDK.

The terminal may be implemented as an autonomous unmanned aerial vehicle equipped with a flight control system, high-resolution camera, microphone, GNSS receiver, communication modules (such as 4G/LTE, Wi-Fi, or satellite communication), and a payload system for loading supplies. The terminal is capable of executing commands received from the server, capturing aerial images and audio, streaming collected data, and transporting items to specific locations.

The user terminal may be a smartphone, tablet, or PC installed with a web or native application that connects to the server. The application provides interactive visualization, live feed display, input for rescue requests and feedback, event notifications, and real-time status updates to the user.

During operation, the terminal (aerial vehicle) is dispatched to disaster-affected or isolated areas according to commands from the server. The terminal captures visual and audio data using its onboard imaging device. This data is transmitted in real time to the server via available communication links. In areas with impaired communication, the server can instruct the terminal to deploy or retrieve external data acquisition devices, such as satellite phones or rugged cameras, which can then be used to collect situational data on site and sync with the system upon reconnection.

The server receives and processes multi-modal data, including but not limited to live video, audio, geospatial coordinates, and environmental sensor data. For advanced scene understanding, the server analyzes the incoming data with a machine learning model. This may include a pre-trained vision model for object and anomaly detection (for instance, using TensorFlow or PyTorch frameworks) and a generative artificial intelligence model that is instructed via prompt sentences.

The prompt sentences are specific, natural language instructions or queries designed to extract relevant information from the AI model. Example prompt sentences used in this invention include:

“Analyze the following camera frame and estimate the abnormal activity score.”

“Given the attached audio clip from the disaster site, please identify if you detect signs of panic or distress.”

“Summarize the emotional tone detected in this video of survivors during the earthquake.”

When a prompt is input together with the data, the server receives a result such as an anomaly score, detected hazards, or emotion classification. Based on these results, the server calculates the optimal rescue or supply delivery route using geographic information and recent mapping data, employing algorithms such as A* or Dijkstra's method (implemented, for example, using the OpenRouteService API).

The server issues updated operation instructions to the terminal, such as new waypoints, target delivery items, or modified priorities. The terminal then executes these instructions, for example, by loading medical supplies and transporting them to the designated destination. Delivery completion can be confirmed by the terminal returning evidence data—such as photos of the site—to the server.

Furthermore, the server estimates the emotional state of identified persons using AI-based emotion recognition modules, such as those provided by deep learning libraries (e.g., DeepFace, OpenFace, or cloud services). Emotional states such as fear or anxiety may be mapped and used to dynamically reprioritize area coverage and rescue operations.

The user receives all updates and controls via the user terminal application, enabling live confirmation of site information, notification of detected hazards, input of field feedback, and viewing of supply transport status. The user can respond directly to recommendations or alerts, which the server collects and uses to further refine actions and coordinate responses with external organizations.

For example, in the case of a major earthquake resulting in isolated urban zones, the user submits a disaster report, the aerial vehicle is dispatched to the scene, visual and audio data are analyzed by the generative AI model via the server using prompt sentences as shown above, and real-time, emotion-sensitive rescue and supply delivery operations are coordinated seamlessly through the user interface and communication infrastructure.

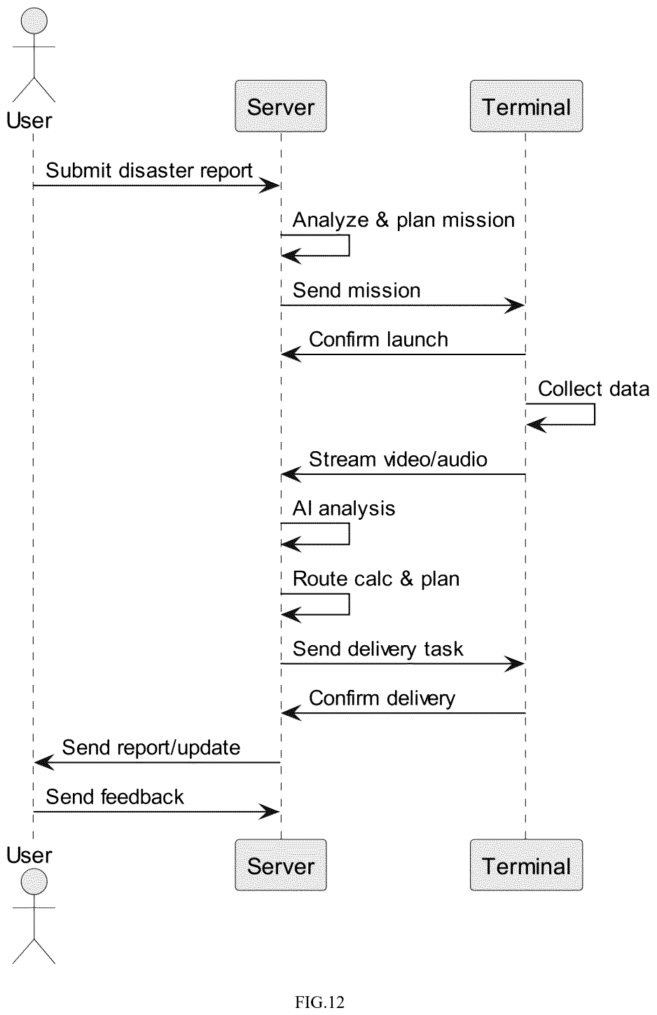

The following describes the processing flow using FIG. 12.

### Step 1:

User submits a disaster event report through a mobile or web application, specifying the type of disaster and affected location.

Input: Disaster event details and location information entered by the user.

Server receives the input, stores the data, and begins preliminary analysis such as verifying location coordinates and fetching related map and weather data.

Output: Validated disaster notification and relevant environmental data for mission planning.

### Step 2:

Server computes an optimal flight route and mission plan for the terminal (aerial vehicle) using map data, weather conditions, and infrastructure status.

Input: Validated disaster site data, map data, and weather data.

Server processes this information using a route planning algorithm (for example, A* or Dijkstra's) to generate a waypoint list and mission parameters.

Output: Flight route data and mission command file for the aerial vehicle.

### Step 3:

Server sends the flight route and mission commands to the terminal for autonomous deployment.

Input: Flight route data and mission command file.

Terminal receives commands, initializes its flight control system, activates navigation sensors, and begins autonomous takeoff and flight toward the disaster location.

Output: Launched terminal en route to the designated area, ready to collect field data.

### Step 4:

Terminal arrives at the assigned location and activates its imaging devices (camera and microphone) to begin collecting live video and audio data.

Input: On-site environmental conditions and mission parameters.

Terminal performs real-time data capture, compresses and streams sensory data, and tags information with GPS coordinates and timestamps.

Output: Live sensory data streams transmitted to the server.

### Step 5:

Server receives the video and audio streams in real time and prepares the data for AI analysis.

Input: Live video and audio streams with metadata (location, time).

Server extracts frames and audio segments, formats them appropriately, and prepares prompt sentences for the generative AI model, such as “Analyze the following camera frame and estimate the abnormal activity score.”

Server inputs the prompts and data into the generative AI model.

Output: AI-generated analysis results, such as anomaly scores or identified hazards.

### Step 6:

Server processes AI results together with geographic and environmental data to determine high-priority zones, detect hazards or victims, and estimate resource needs.

Input: AI analysis results, geographic information, and environmental sensor data.

Server uses data processing algorithms to correlate hazards, locate victims, and assess required supplies, then calculates the optimal rescue or delivery route based on current conditions.

Output: Prioritized action plans and calculated delivery or rescue routes.

### Step 7:

Server issues updated commands to the terminal, specifying new routes or instructions for loading and delivering supplies to target locations.

Input: Action plan, supply requirements, and updated route information.

Terminal receives new instructions, loads designated medical or relief supplies (either automatically or via ground staff), and autonomously travels to the intended location.

Terminal confirms delivery by capturing images or sending sensor-based confirmation back to the server.

Output: Supplies delivered and delivery confirmation data returned to the server.

### Step 8:

Server utilizes emotion recognition models to estimate the emotional state of individuals detected in the video or audio streams.

Input: Audio and video data of affected persons, prompt sentences for emotion analysis (e.g., “Summarize the emotional tone detected in this video of survivors”).

Server processes this data with an emotion estimation model, maps emotional states onto a digital interface, and dynamically reprioritizes further operations based on zones of distress or urgency.

Output: Emotional analysis results and adjusted operational priorities.

### Step 9:

User terminal receives real-time updates, including live video, rescue recommendations, supply status, and emotional state mapping via the application interface.

Input: Action plans, live feeds, AI-derived analysis, and notifications from the server.

User reviews the information, provides field feedback, acknowledges actions, or issues additional requests via the app.

Output: User feedback and field data submitted to the server, closing the situational awareness and feedback loop.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In disaster situations, existing systems often suffer from delayed and inaccurate collection of site information, resulting in inefficient deployment of rescue operations and misallocation of relief resources. Moreover, these systems rarely consider the emotional status of affected individuals, making it difficult to prioritize and adapt rescue activities to provide appropriate psychological care and support. There is a need for a system capable of real-time, accurate site information gathering, dynamic rescue planning, and adaptive prioritization based on multi-modal data, including the emotional state of individuals in affected areas.

The specific processing by the specific processing unit 290 of the data processing device 12 in Example 2 is realized by the following means.

The present invention provides a server comprising a processor configured to control an aerial vehicle for site information collection, acquire and analyze multi-modal disaster data in real time using artificial intelligence technologies, identify disaster situations and affected regions, calculate optimal rescue and resource delivery routes, deploy communication devices in blackout areas for additional data collection, generate and communicate emergency response information to external support agencies, analyze the emotional state of affected individuals, dynamically adjust rescue task priorities, and interpret user-input natural language commands for flexible system operation. This enables rapid, accurate information gathering, efficient allocation of resources, consideration of the emotional needs of disaster victims, and fully adaptive and responsive rescue planning in disaster environments.

The term “aerial vehicle” refers to an unmanned mobile device capable of flight, such as a drone or remotely operated flying apparatus, used for collecting data or transporting items in a given area.

The term “imaging apparatus” refers to a hardware device or system capable of capturing still images and motion images, such as a camera or a video recording device, which may be mounted on an aerial vehicle.

The term “artificial intelligence processing unit” refers to a computing resource or software system that utilizes machine learning, deep learning, or other artificial intelligence algorithms to analyze and interpret collected data in real time.

The term “machine learning model” refers to a computer algorithm or trained statistical model capable of recognizing patterns, classifying objects, and extracting features from data such as images or audio.

The term “image recognition” refers to the automated process of identifying and classifying objects, features, or scenes within captured image data using computer vision technologies.

The term “speech recognition” refers to the automated process of transcribing or interpreting spoken language in audio data into text or actionable information using computational algorithms.

The term “emergency response area” refers to a specific geographic region identified as requiring urgent intervention, rescue, or relief actions based on analysis of collected disaster data.

The term “information processing unit” refers to a computational module or processor configured to aggregate, process, and analyze input data and execute logical operations required for decision making.

The term “relief resources” refers to physical goods or materials, such as food, water, medical supplies, or other aid, intended for delivery to individuals or areas affected by a disaster.

The term “communication device” refers to any equipment, such as a satellite phone or digital transmitter, provided to enable data transmission in areas where traditional communication infrastructure is unavailable.

The term “recording device” refers to any electronic apparatus capable of storing data such as images, audio, or other sensory information for later retrieval and transmission.

The term “emergency response information” refers to organized and actionable data or notifications generated from analyzed disaster data and intended to inform or direct rescue operations and external support agencies.

The term “support agency” refers to an external organization, entity, or institution tasked with providing aid, rescue, logistics, or other forms of assistance during disaster response activities.

The term “emotion analysis technology” refers to computational methods and algorithms designed to infer or classify emotional states of individuals based on inputs such as speech, facial expression, or biometric data.

The term “user” refers to an operator or authorized person who interacts with the system, inputs queries, or issues commands, often to manage, monitor, or adjust disaster response operations.

The term “natural language command” refers to an instruction or query that is expressed in human-understandable language and processed by the system to perform specific tasks or provide information.

The term “generative model response unit” refers to a hardware-implemented or software-implemented module utilizing generative artificial intelligence models to interpret, process, and respond to user input or disaster scenario requirements.

The server executes a programmed process designed to coordinate disaster response operations by integrating data collection, artificial intelligence analysis, and adaptive decision making. The system consists primarily of a server including at least one processor, one or more aerial vehicles (terminals), various sensor and imaging apparatuses, and interfaces for user interaction.

The server initiates the operation by acquiring data related to a disaster event. This is accomplished by first receiving notification from an external alert system. The server then accesses map data, weather data, and shelter information from external databases through standardized APIs. For instance, the server may utilize an online mapping service API for geographic data, a meteorological data API for real-time weather data, and a government database server for official shelter locations. These datasets are integrated and stored in a structured data management system, such as a relational database.

The terminal, implemented as an aerial vehicle equipped with an onboard imaging apparatus (such as a high-resolution camera and a microphone), is controlled by the server to fly to specific geographic coordinates. The terminal uses its autopilot module, GPS module, and embedded sensors to navigate autonomously, collect visual and audio information, and relay the data to the server in real time using wireless communications (for example, via an LTE/5G modem). If the area is outside network coverage, the terminal records data to internal memory for later retrieval.

On the server side, the processor preprocesses collected image data using image-processing libraries such as OpenCV, and audio data is preprocessed by denoising and segmenting using standard audio-processing software (such as librosa). The server then analyzes the visual data using a machine learning model (for example, using TensorFlow or PyTorch as a software framework and a pre-trained object recognition algorithm) to detect collapsed buildings, blocked roads, or other hazards. Audio data is transcribed to text format using a speech recognition API (such as a widely available speech-to-text cloud service). The server inputs the preprocessed data into a generative AI model, which can interpret complex disaster situations, anticipate the need for relief resources, and produce recommendations for rescue actions. The server uses a route calculation algorithm (implemented, for instance, with the A* or Dijkstra algorithm) to generate optimal rescue and relief delivery paths while considering detected hazards.

Emotion analysis is implemented by the server using an emotion analysis technology (such as a deep learning-based classifier working on transcribed text and facial recognition from video data). The result of the emotion analysis informs the prioritization algorithm, allowing the system to dynamically allocate resources based on the physical and psychological needs of affected individuals.

For areas with destroyed or inoperable communication infrastructure, the server instructs an aerial vehicle to deliver communication equipment (such as a portable satellite phone or a digital camera) to on-site responders, who then capture and return data using the supplied devices. This data is integrated into the server's ongoing analysis cycle.

The server generates emergency response information based on the multi-modal analyzed data. This may include geo-coordinates of critical incidents, resource requirements, survivor status, and emotional status summaries. This information is communicated to external support agencies through secure interfaces, such as RESTful APIs or automated messaging systems.

The user interacts with the server via a user interface that allows viewing live mapping, status dashboards, and recommended actions. The user can also input a prompt sentence—a natural language request or command—to the generative AI model for scenario-specific support or additional planning. For example, the user may enter the following prompt:

“An earthquake of magnitude 7 has occurred, isolating part of an urban area. Dispatch drones to rapidly collect on-site disaster information, compute rescue routes, and develop the best possible plan to deliver required supplies. Also, use the collected audio and video data of survivors to analyze their emotional state, and dynamically adjust the priorities of relief efforts based on emotion analysis.”

The server interprets such prompt sentences using the generative AI model, integrating the result into the task scheduling and mission planning process.

In sum, the embodiment described enables a highly automated, responsive disaster response system combining aerial data acquisition, multi-modal AI analysis, dynamic resource allocation, and user-driven adaptive planning. The use of described hardware and software enables realization of the full technical scope of the invention.

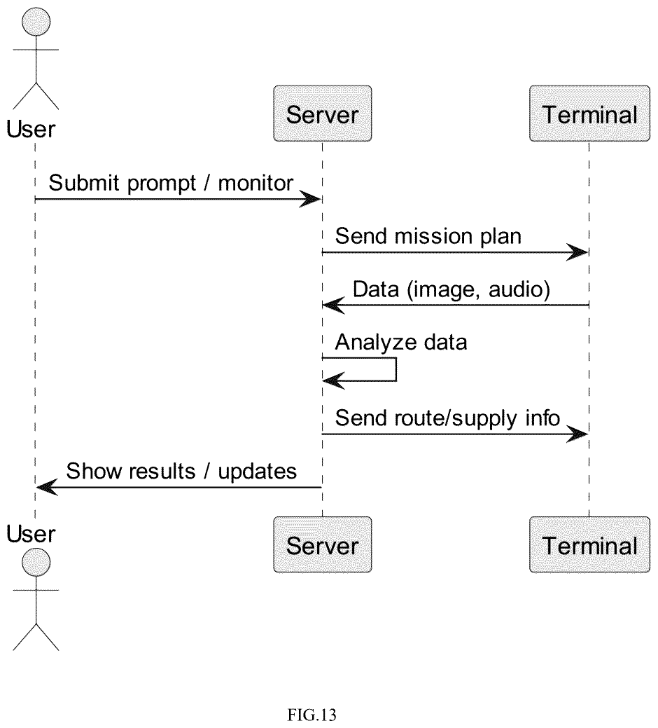

The following describes the processing flow using FIG. 13.

### Step 1:

The server receives a disaster notification from an external monitoring system or authority through a standardized API.

Input: Disaster occurrence signal (e.g., earthquake alert).

The server retrieves geographical information, weather data, and shelter lists from external databases. Using these inputs, the server processes and integrates multiple datasets to identify target areas and determine preliminary drone dispatch plans.

Output: Integrated disaster area dataset, preliminary drone mission plan.

### Step 2:

The server transmits a detailed mission plan to the terminal (aerial vehicle), specifying coordinates for data collection and types of sensor usage (camera, microphone).

Input: Drone mission plan with coordinates and data type instructions.

The server packages this information in a protocol understood by the terminal and establishes a communication link for remote control.

Output: Transmitted mission plan and established control link.

### Step 3:

The terminal (aerial vehicle) receives the mission plan and autonomously flies to designated locations using its GPS and onboard flight control system.

Input: Mission plan data such as waypoints and operational instructions.

The terminal processes this input via its autopilot system, navigates accordingly, manages real-time route data, and performs error correction if required based on sensor feedback.

Output: Arrival at target points and readiness for data collection.

### Step 4:

The terminal utilizes its camera and microphone to capture high-resolution visual and audio data at assigned locations.

Input: Capture command and sensor configuration from the mission plan.

The terminal processes environmental data, records 4K video, still images, and audio, and prepares information packets.

Output: Collected raw visual and audio data.

### Step 5:

The terminal transmits the collected data to the server in real time using a wireless communication module (LTE/5G). If coverage is unavailable, the terminal stores data locally and prepares for later transmission.

Input: Collected visual and audio datasets.

The terminal compresses and packetizes the data for efficient transmission and maintains logs for quality assurance.

Output: Data stream to server or local data storage log.

### Step 6:

The server receives the incoming data and stores it in a structured storage system.

Input: Visual and audio data streams/files.

The server employs image processing (e.g., using OpenCV) to normalize images, and applies noise filtering to audio using audio-processing libraries (e.g., librosa).

Output: Preprocessed and organized image and audio datasets.

### Step 7:

The server analyzes the image data using a machine learning model such as TensorFlow or PyTorch, detecting features like collapsed buildings and blocked routes.

Input: Preprocessed image data.

The server performs object detection and classifies recognized items via deep learning inference.

Output: Detected features, disaster situation reports, structured annotations.

### Step 8:

The server converts audio data to text using speech-to-text technology and processes transcripts using a generative AI model to extract relevant scenario details and supply requirements.

Input: Audio data from terminal; preprocessed transcripts.

The server analyzes speech for distress keywords, request detection, or location mentions by combining generative AI model and keyword extraction algorithms.

Output: Transcribed text, extracted needs, and survivor status data.

### Step 9:

The server conducts emotion analysis by inputting transcripts and image data to an emotion recognition pipeline, determining emotional states (e.g., panic, calm).

Input: Survivor images and transcribed speech.

The server calculates sentiment metrics and classifies emotion categories using deep neural network models.

Output: Emotional state assessments for survivors.

### Step 10:

The server computes optimal rescue and supply deployment routes using algorithms such as A* or Dijkstra, taking into account hazards and emotional status data.

Input: Feature maps, hazard annotations, emotional state data.

The server performs spatial graph construction and pathfinding computations for route optimization.

Output: Optimized rescue and delivery route plans.

### Step 11:

The server generates emergency response information, compiles actionable summaries, and automatically communicates these to external support agencies via secured interfaces.

Input: Integrated assessment of site conditions, needs, and priorities.

The server formats notifications and delivers them as structured messages or files.

Output: Emergency response notifications to support agencies.

### Step 12:

The user accesses the interface to monitor maps, status dashboards, and recommendations, and may input a prompt sentence describing additional requirements or desired actions.

Input: Displayed disaster status; user-entered prompt sentence (natural language command).

The user reviews visualized data and interacts with the generative AI model by providing scenario-specific instructions, which are interpreted by the system to adjust operations.

Output: Updated plans, actions or adjustments based on user's prompt.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In disaster situations, rapid and accurate initial response is hindered by a lack of real-time situational awareness, especially in areas where communication infrastructure is disrupted. Furthermore, conventional systems do not adequately consider the emotional states and urgent needs of affected individuals when prioritizing rescue operations and supply delivery. There is a need for a system capable of integrating aerial surveillance, real-time data analysis, emotion recognition, and dynamic route and priority optimization, in order to efficiently support targeted disaster response and relief activities.

The specific processing by the specific processing unit 290 of the data processing device 12 in Application Example 2 is realized by the following means.

The present invention provides a server comprising a processor configured to remotely or autonomously control an operable aerial vehicle, collect and analyze image, video, and audio data in real time via artificial intelligence, derive optimal rescue or transportation routes based on situational and spatial analysis, acquire and analyze user location and emotional data from portable terminals using a generative artificial intelligence model, dynamically adjust prioritization of support activities based on emotional analysis, and generate as well as transmit emergency response information and mission results to users and external relief organizations. This enables efficient, data-driven, and human-centered disaster response and logistics operations, even in environments with impaired communications, by integrating situational intelligence, emotion-based prioritization, and automated prompt generation for advanced artificial intelligence processing.

The term “processor” refers to an electronic data processing unit or computing device configured to execute programmed instructions and manage data processing functions within the system.

The term “operable aerial vehicle” refers to an unmanned aircraft, such as a drone, that is capable of being remotely or autonomously controlled to perform surveillance, transportation, or data acquisition tasks.

The term “imaging device” refers to a device, such as a camera or an optical sensor, that captures still or moving visual information from the environment.

The term “acoustic information acquisition device” refers to a device, such as a microphone or audio sensor, that is capable of capturing sound or audio data from the environment.

The term “artificial intelligence processing device” refers to a processing system, hardware or software, that implements algorithms for analyzing and interpreting data using artificial intelligence or machine learning methods.

The term “route search algorithm” refers to a computational method or process executed by the processor to determine an optimal path or movement route based on input data, such as environmental or situational information.

The term “transport control device” refers to a system or module used to direct and manage the loading, transportation, and delivery of supplies or materials by the operable aerial vehicle.

The term “wireless communication device” refers to any communication module that operates using radio waves, and is capable of transmitting and receiving data wirelessly.

The term “device with a satellite communication function” refers to a communication module or terminal that can transmit data to and receive data from satellites, enabling connectivity in areas lacking terrestrial networks.

The term “information collection device” refers to hardware, software, or combined subsystems used to gather data, including but not limited to environmental, situational, or status information, from the field.

The term “data analysis device” refers to a processing unit or subsystem equipped with hardware and/or software for analyzing structured or unstructured data to extract relevant information or insights.

The term “information communication device” refers to any means or subsystem responsible for transmitting or distributing information from the system to other devices, organizations, or users.

The term “portable information processing terminal” refers to a mobile computing device, such as a smartphone or tablet, capable of collecting and transmitting data from users.

The term “generative artificial intelligence model” refers to a computer model based on machine learning techniques that is capable of generating, interpreting, or analyzing content, including natural language and sensory data.

The term “prompt sentence” refers to a textual or structured input provided to a generative artificial intelligence model to guide or elicit a desired analytical or generative response.

The term “emotional information” refers to data relating to the psychological state or feelings of a user, which may be collected through text, speech, or other input methods and analyzed for emotion recognition.

The term “priority of support activities” refers to the sequence or ranking of actions and resource allocations in disaster response, adjusted dynamically according to analysis of situational and emotional data.

The term “information presentation device” refers to hardware or software that displays, conveys, or communicates processed results or instructions to users or organizations.

An embodiment of the present invention provides a disaster response system configured to support rapid and accurate situational assessment, emotion-aware prioritization, and efficient allocation of relief resources.

The server includes a processor which functions as the central command and analysis unit. The processor is connected to a data network for communication with aerial vehicles, portable terminals, and external organizations. The server is implemented using high-performance generic server hardware such as rack-mount servers equipped with general-purpose CPUs and, optionally, graphics processing units (GPUs) for artificial intelligence operations. The server runs commonly used operating systems and middleware, such as Linux or Windows Server, and is programmed using software frameworks such as Python, TensorFlow, or PyTorch for machine learning and artificial intelligence processing.

The system employs one or more operable aerial vehicles equipped with imaging devices (such as high-resolution cameras) and acoustic information acquisition devices (such as microphones). These aerial vehicles are capable of both remote and autonomous operation, and may be implemented using commercially available unmanned aerial vehicles adapted for disaster surveillance and cargo transport. The aerial vehicles include wireless communication devices or satellite communication modules to maintain data link connectivity, even in areas with disrupted terrestrial networks.

When a disaster occurs, the server receives alerts, gathers map data, weather information, and shelter data from public databases and APIs, and integrates this information to create a spatial and situational data record. The processor assigns aerial vehicles to survey specific locations based on initial hazard assessment, and transmits detailed mission commands, including the required data types (image, video, audio) and collection waypoints.

Upon receipt of the mission, the terminal (aerial vehicle) autonomously executes the mission plan, captures imagery and audio at designated locations, and uses communication modules to stream the collected data back to the server in real time. File formats such as JPEG for images, H.265 for video, and FLAC for audio are employed for efficient encoding and transmission.

The server processes the incoming data using machine learning models. For example, image analysis is performed using convolutional neural networks implemented with TensorFlow or PyTorch to identify collapsed infrastructure and hazardous zones. Audio data are transcribed using standard speech-to-text APIs and further analyzed using generative artificial intelligence models, which can summarize events or detect signs of distress.

Using the derived analysis, the server recalculates optimal support routes for rescue operations and logistics delivery. Route search algorithms such as Dijkstra's algorithm are implemented in the data processing software. The results are transmitted to relief organizations and, when required, to the aerial vehicles as an update to their mission routes.

The users, typically disaster victims, interact with the system through a portable information processing terminal, like a smartphone or tablet. The terminal is equipped with software capable of collecting the user's location through GPS and accepting emotional status input in the form of typed text or voice messages. The emotional status message, for example, “I am very scared; people around me are crying,” is collected by the terminal and transmitted to the server for analysis.

The server applies a generative artificial intelligence model—such as a large language model implemented in PyTorch or TensorFlow—to the received emotional input and automatically extracts levels of fear, anxiety, and urgency. Based on aggregated emotion data from multiple users and situational analysis, the server dynamically re-prioritizes support activities, ensuring that high-distress zones receive the fastest and most substantial assistance.

The system can generate and utilize prompt sentences for the generative artificial intelligence models. These prompts guide the analysis of user-submitted data and the production of support recommendations. For example, a prompt sentence may be:

“The user's current location is Tokyo, and the surrounding area is highly chaotic. The emotional message entered is: ‘I am very scared; people around me are crying.’ Please display the optimal evacuation route and the analyzed emotional state.”

Based on such input, the artificial intelligence model returns a summary of the local emotional context, an assessment of urgency, and recommendations for evacuation or support, which the server then forwards as instructions to the relief organizations and responder teams. Through this configuration, the system enables integrated data-driven disaster response and resource prioritization that is sensitive to both on-the-ground physical needs and the psychological well-being of affected individuals. All components interact with each other via robust, secure communication interfaces, allowing coordinated relief efforts even in conditions where conventional communications are impaired or unavailable.

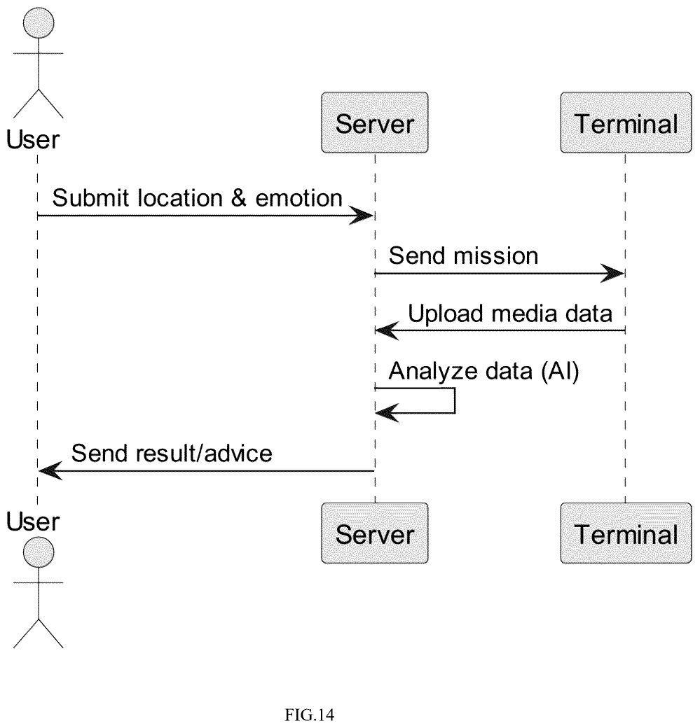

The following describes the processing flow using FIG. 14.

### Step 1:

The server receives disaster notification data and gathers relevant geographical, weather, and shelter information from external public data sources (such as APIs and databases). The input for this step is the disaster alert signal and API data, and the output is a structured, integrated disaster situation dataset. The server preprocesses the incoming data by standardizing formats, extracting essential metadata, and storing the results in a spatial database.

### Step 2:

The server analyzes the integrated dataset and calculates initial surveying routes by using a route search algorithm. The input is the integrated disaster situation dataset from Step 1, and the output is a set of task assignments for aerial vehicles, including flight paths and target locations. The server optimizes waypoints and mission parameters, and then generates and transmits command packets to each aerial vehicle.

### Step 3:

The terminal (aerial vehicle) receives the assigned mission details and autonomously departs to the designated area. The input is the received command packet, and the output is the collection of raw images, video, and audio at the specified locations. The terminal performs imaging and audio recording, timestamps and geo-tags the media files, and stores them locally or transmits them when network connectivity is available.

### Step 4:

The terminal transmits the collected media data to the server using a wireless or satellite communication link. The input for this step is the locally stored set of media files, and the output is a secure data stream sent to the server's receiving endpoint. The terminal compresses and formats the data for efficient transmission and authenticates the connection with the server.

### Step 5:

The server receives the incoming data, stores it, and applies artificial intelligence models to analyze the images, video, and audio. The input is the received media data, and the output is a set of analysis results, such as detected hazards, location of victims, or summary of events. The server performs feature extraction, object detection, and speech-to-text conversion, and then summarizes key findings using a generative AI model.

### Step 6:

The server recalculates optimal routes for relief efforts and support supply delivery using the situational awareness obtained. The input for this step is the analysis results from Step 5, and the output is an updated set of recommended movement routes for responders and aerial vehicles. The server excludes impassable routes and reorders support priorities based on newly detected hazards.

### Step 7:

The user interacts with a portable information terminal (such as a smartphone) to input their current location and emotional status via text or voice. The input is the user's manual data entry, and the output is a structured user report sent to the server. The terminal uses GPS functionality and, if necessary, speech-to-text software to digitize spoken emotional messages.

### Step 8:

The server analyzes the user's report to evaluate emotional state using a generative AI model and generates a prompt sentence to guide this analysis. The input is the structured user report and generated prompt sentence, and the output is an emotional assessment (for example, levels of fear or urgency) mapped to the user's location. The server applies a language model or emotion recognition model to extract and score the user's emotion, updating the situation database accordingly.

### Step 9:

The server integrates emotion information from multiple users and the current disaster situation analysis to dynamically adjust the priority of support activities. The input is the combined situational and emotional data, and the output is an updated prioritization for aid delivery and rescue missions. The server reprioritizes resources and updates mission assignments for responders and aerial vehicles accordingly.

### Step 10:

The terminal (aerial vehicle) receives the latest mission updates, which reflect the renewed priorities and optimal routes, and executes delivery of supplies or additional surveillance as instructed. The input is the new mission directive, and the output is either successful supply delivery or updated surveillance data returned to the server. The terminal confirms task completion or restarts the data capture and delivery cycle as needed.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

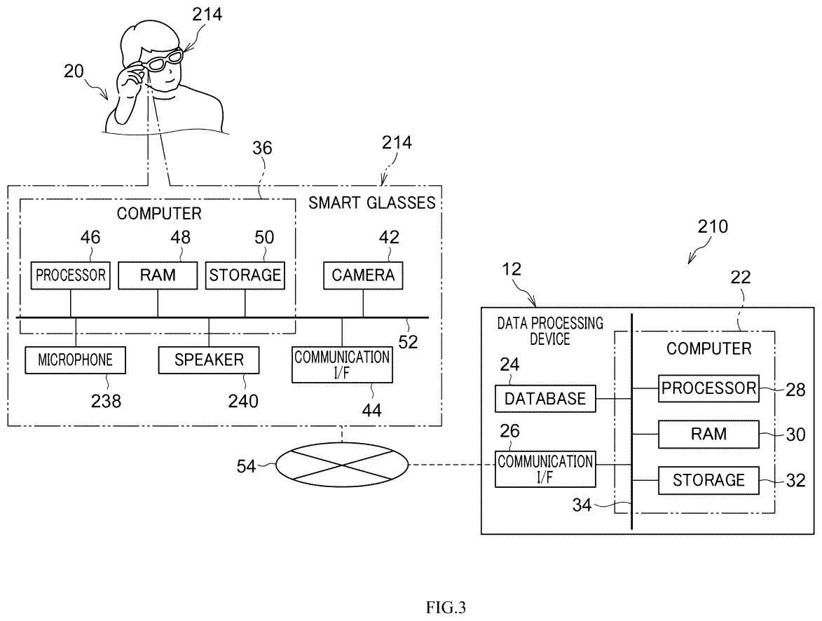

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

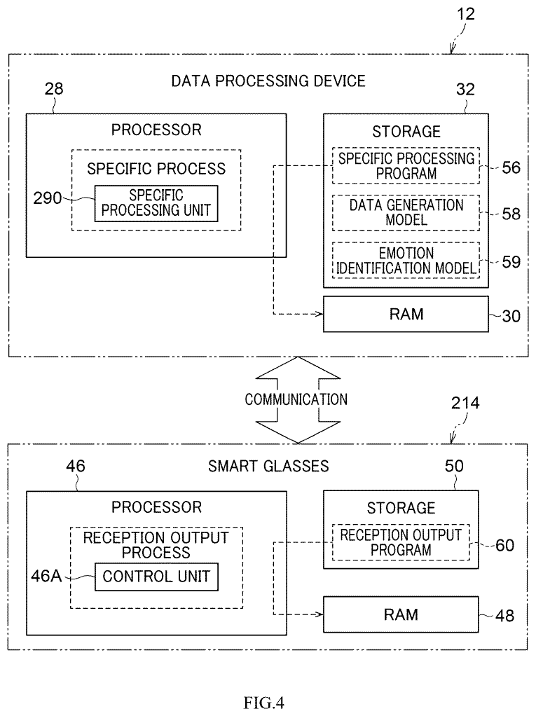

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

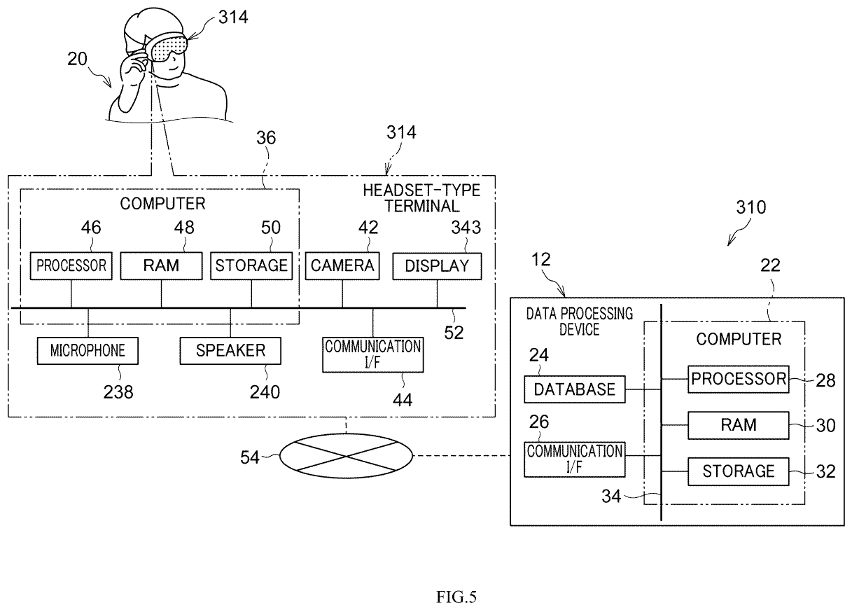

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

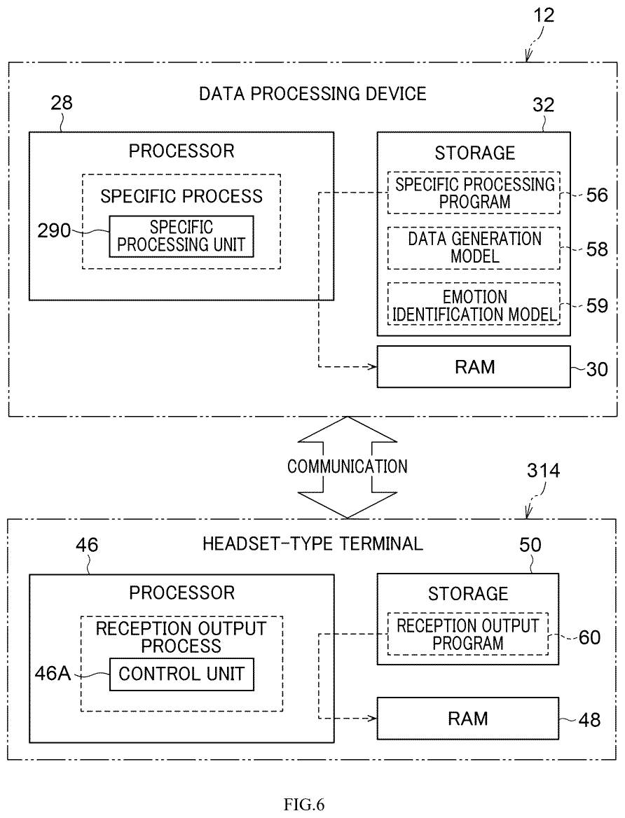

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

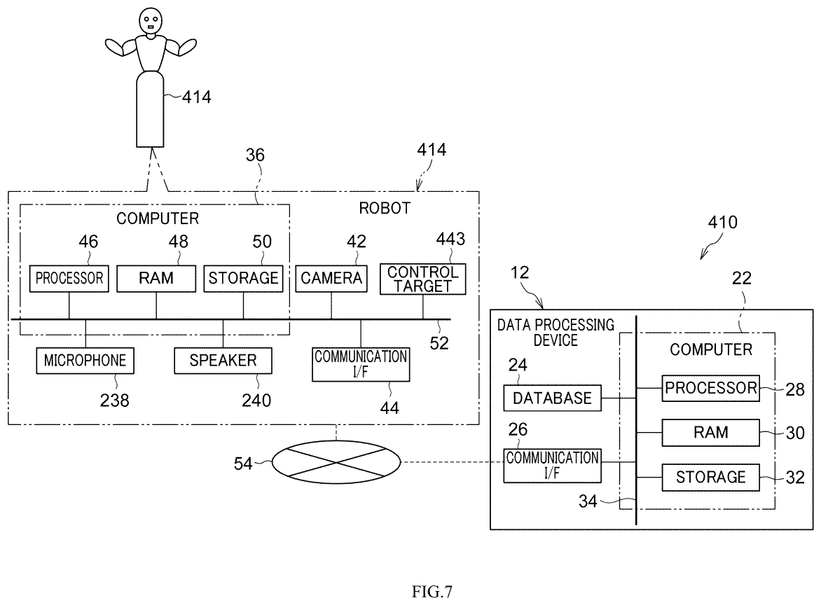

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

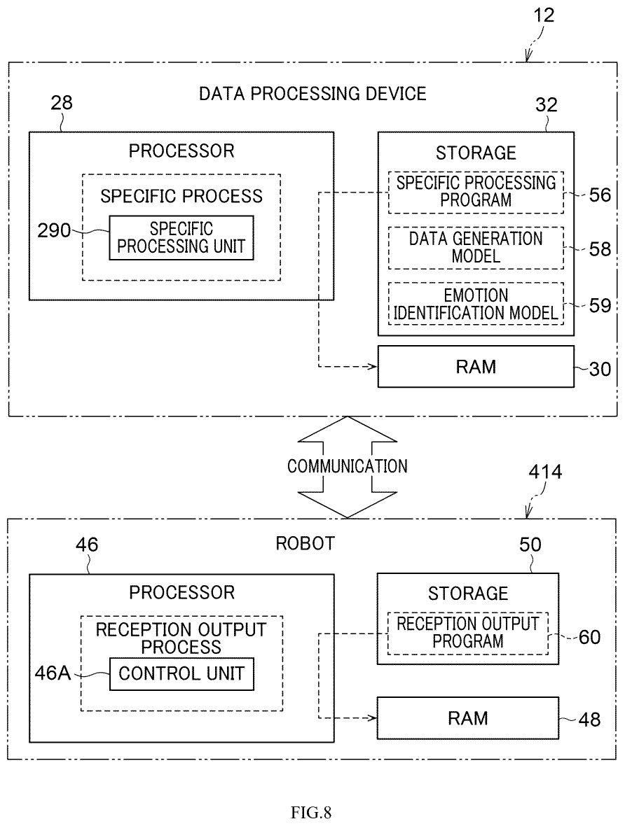

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

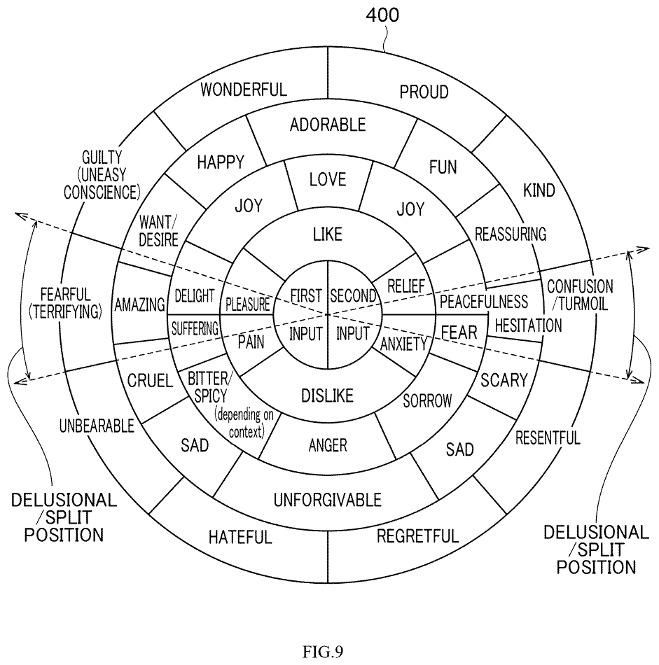

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o′clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more”and “want to know more”is experienced.

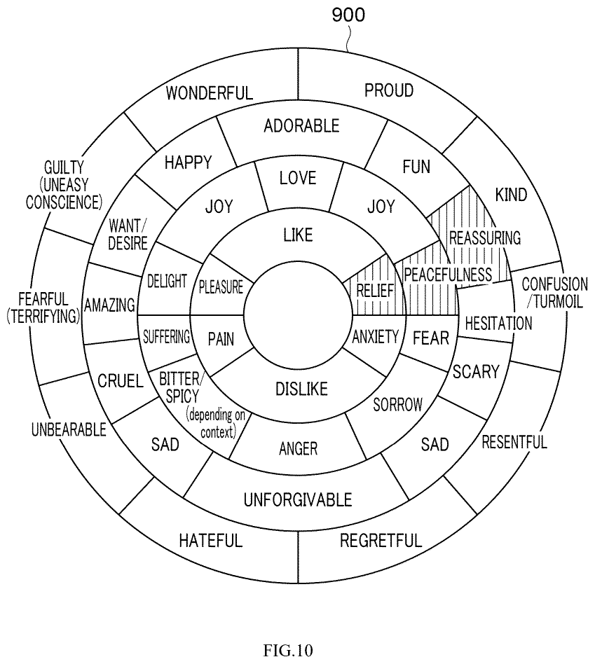

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
collect various types of information with an unmanned mobile apparatus and an image acquisition apparatus,
acquire data and status in real time via a network and perform analysis using an artificial intelligence processing module,
calculate an optimal rescue movement route based on the analysis results, geographic information, and obstacle information using a route calculation module,
instruct the unmanned mobile apparatus to autonomously transport goods to a designated location based on the calculated route,
deploy information acquisition equipment in a region where communication is interrupted and collect local status data via the unmanned mobile apparatus,
analyze the collected data and local status to generate emergency response information using an emergency information generation module,
transmit the generated emergency response information to external terminals of relief agencies via a network,
execute generation of a situational analysis or an action plan using a generative artificial intelligence model in response to an input prompt sentence, and
generate the prompt sentence for input to the generative artificial intelligence model.

### (Supplementary 2)

The system according to supplementary 1,
wherein the processor is configured to operate the unmanned mobile apparatus in accordance with instructions based on the analysis results and information provided by the route calculation module.

### (Supplementary 3)

The system according to supplementary 1,
wherein the processor is configured to determine an optimal transportation plan and movement route for supplying goods based on the results analyzed by the artificial intelligence processing module and the route calculation module, and to execute the transportation.

### Application Example 1

### (Supplementary 1)

A system comprising a processor,
wherein the processor is configured to
control an aerial vehicle for autonomous flight,
acquire visual and audio information with an imaging device, analyze acquired multi-modal data in real time using a machine learning model and detect anomalies,
calculate an optimal route using geographic information and obstacle data based on the analysis result,
control loading and transporting of supplies on the aerial vehicle according to the calculated route information,
deploy information acquisition devices in communication-impaired regions for local data collection,
input prompt sentences and acquired sensory data to a generative artificial intelligence model to extract abnormality scores or specific situations,
share extracted emergency information and action proposal data with related organizations via an external communication interface,
estimate the emotional state of a person from audio or video data and reflect the estimation in the priority of rescue actions, and
provide a user interface to enable real-time confirmation of site information, route instructions, feedback input, and actions history transmission and reception from a user terminal.

### (Supplementary 2)

The system according to supplementary 1,
wherein the processor is configured to autonomously and dynamically adjust flight routes and operation details of the aerial vehicle based on results of the machine learning model analysis and the emotion estimation analysis.

### (Supplementary 3)

The system according to supplementary 1,
wherein the processor is configured to determine and execute the type and route of supply transport based on the analysis result of the generative artificial intelligence model and the optimal route calculated by the route calculation function.

### Example 2

### (Supplementary 1)

A system comprising a processor,
wherein the processor is configured to
control an aerial vehicle to collect site information including audio and video data, acquire still image or motion image data using an imaging apparatus,
preprocess and analyze spatiotemporal data in real time using an artificial intelligence processing unit,
identify disaster situations using a machine learning model including image recognition and speech recognition technologies,
automatically calculate emergency response areas and optimal routes based on analysis results using an information processing unit,
manage transport of relief resources by the aerial vehicle to a target location,
deploy a communication device or recording device to a site where communication is lost to enable additional data collection via on-site responders,
generate emergency response information automatically based on collected and analyzed multiple types of data,
automatically communicate the emergency response information to a predetermined external support agency,
analyze emotion states by processing audio and video information collected from affected individuals using emotion analysis technology,
dynamically adjust the priority of rescue operations according to the analysis result of emotional states, and
interpret and reflect inquiry sentences or command sentences in natural language input by a user in a processing plan through a generative model response unit.

### (Supplementary 2)

The system according to supplementary 1,
wherein the processor is configured to
enable the aerial vehicle to operate based on the analysis results or command sentences provided by the artificial intelligence processing unit or the generative model response unit.

### (Supplementary 3)

The system according to supplementary 1,
wherein the processor is configured to
dynamically select an optimal transport route or transport plan for relief resources based on analysis information or responses obtained from the artificial intelligence processing unit or the generative model response unit.

### Application Example 2

### (Supplementary 1)

A system comprising a processor,
wherein the processor is configured to
remotely control or autonomously control an operable aerial vehicle,
acquire field information by using an imaging device and an acoustic information acquisition device,
analyze and process, in real time, still image data, video data, and audio data acquired by the aerial vehicle by using an artificial intelligence processing device, derive an optimal movement route based on the analyzed spatial information and situational information by using a route search algorithm executed on an information processing device,
control transportation of support supplies by mounting the supplies on the aerial vehicle and transporting them to a target area along the derived movement route by using a transport control device,
deploy a wireless communication device or a device with a satellite communication function in an area with disrupted communication to acquire local situation data and environment information by using an information collection device,
analyze the acquired data and generate emergency response information by using a data analysis device,
transmit the generated emergency response information to an external relief organization or support agency by using an information communication device,
acquire user location information and emotional information by using a portable information processing terminal,
analyze the acquired emotional information by using a generative artificial intelligence model and dynamically adjust priority of support activities based on the analysis result,
output the analysis and priority adjustment results, and optimal movement route, to the user or relief organization by using an information presentation device, and
generate prompt sentences for the analysis and priority adjustment processes, and input the prompt sentences into the generative artificial intelligence model.

### (Supplementary 2)

The system according to supplementary 1,
wherein the processor is configured to control operation of the operable aerial vehicle based on analysis results or priority adjustment results obtained by the artificial intelligence processing device or by the route search algorithm.

### (Supplementary 3)

The system according to supplementary 1,
wherein the processor is configured to determine an optimal transportation route and transportation order of the support supplies based on the spatial information, situational information, and emotional information generated by the artificial intelligence processing device.

What is claimed is:

1. A system comprising a processor, wherein the processor is configured to:
control an operable flying device;
control an operable imaging means;
perform real-time analysis of generated data using artificial intelligence processing means;
calculate an optimal rescue route based on the analysis results;
control means for loading and transporting supplies with the flying device;
control means for deploying equipment in regions where communication is disrupted and collecting local condition data;
analyze the collected data to generate emergency response information; and
communicate the emergency response information to external rescue organizations.

2. The system of claim 1, wherein the operable flying device is configured to operate based on the analysis results.

3. The system of claim 1, wherein the means for loading and transporting supplies selects an optimal transport route using the generated data.
